(19) United States
(12) Patent Application Publication
(10) Pub. No.: US 2008/0172324 A1
(43) Pub. Date: Jul. 17, 2008

(54) System and method for modifying criteria used with decision engines

(76) Inventor: Tom Johnson, Bozeman, MT (US)

Correspondence Address: MORRISON & FOERSTER LLP, 755 PAGE MILL RD, PALO ALTO, CA, 94304-1018, US

(21) Appl. No.: 10/910,395

(22) Filed: Aug. 3, 2004

(51) Int. Cl. G06Q 40/00

(52) U.S. Cl. 705/38

(57) ABSTRACT

The present invention comprises a system and method for modifying and testing criteria attributes used with decision engines. The criteria attribute unit (10) receives proposed criteria attribute data from the proposed criteria input source (5). If the proposed criteria attribute data qualifies as acceptable criteria attribute data as reflected in the acceptable criteria storage unit (15), then the proposed criteria attribute data is stored in the active criteria storage unit (20). If the proposed criteria attribute data qualifies as unacceptable criteria attribute data as reflected in the unacceptable criteria storage unit (35), then the proposed criteria attribute data is disregarded. If the proposed criteria attribute data is neither acceptable nor unacceptable criteria attribute data, then the data is stored in the untested criteria storage unit (30). Active criteria attribute data is provided to the decision processor (25) for processing.

### FIELD OF THE INVENTION

The present invention relates generally to credit approval systems and methods, and, more particularly, to credit approval systems and methods using decisioning criteria.

### BACKGROUND OF THE INVENTION

Business institutions, such as banks, extend credit or lend money to consumers. Essentially, these business institutions lend money to make money. Deciding which consumers are credit-worthy is not always an easy task. Historically, lenders relied on human judgment to determine who received credit. Using past experience as a guide, lenders observed consumer credit behavior as the standard for judging new consumers. The decision could be based on subjective criteria such as a consumer having too much debt or too many late payments. Often, lenders made decisions based on personal opinion, which frequently had little relevance to a consumer's ability to repay debt. The entire credit approval process was very slow and unreliable, because of human error and bias.

In response to the rise in demand for a more reliable source of consumer credit information, credit bureaus developed which stored credit history information. Three major national consumer bureaus presently exist in the United States. Creditors provide the bureaus with information about the consumers' payment history. The bureaus compile the information and obtain public record information to include in credit reports. The bureaus then make the reports available to creditors for deciding whether to approve new applicants for credit. Credit reports contain useful information for creditors to examine in determining the credit-worthiness of an applicant. For example, a credit report provides information such as the number of times the applicant has recently applied for credit and any public records related to the applicant's credit. Credit reports also include personal information, credit history information, public record information, and credit inquiry information. The personal information found in a credit report includes the applicant's name, address, phone number, social security number, current and previous employers, and previous home addresses. The credit history information includes late payments, outstanding debt, and the total amount of credit available to the applicant. The public records information includes any filings by the applicant for bankruptcy and court judgments against the applicant. The credit inquiry information provides lenders with a list of recent inquiries for credit. Such inquiries let a business institution decide whether the applicant is desperate to obtain credit, is trying to defraud the credit system, or is simply trying to obtain too much credit.

Over time, lenders created a standard on how to make credit decisions by using a point system. The point system scores different variables found on the consumer's credit report. Variables in the credit report used to calculate a credit score include: number and severity of late payments, the total amount of debt, the number of accounts, the type of accounts, the age of the accounts, and any recent inquiries. The goal of the point system is to accurately predict the future credit behavior of an applicant. The point system or credit score assists lenders in determining the risk involved in extending credit to a certain consumer. Consumers also benefit from the scoring system, because now the decision to extend credit is based on the ability to repay debt, and not based on subjective criteria such as race, religion, national origin, sex, and marital status.

In addition to the credit score determined by the credit report, each business institution may have its own set of decisioning criteria used in conjunction with the credit information to determine whether to approve or reject an application. Decisioning criteria consist of custom thresholds and requirements that establish a lending institution's rules, specifications, or tests used to reach a conclusion on an issue under consideration. In the lending industry, the decisioning criteria govern whether an individual is granted or denied credit. After receiving a credit report from a credit bureau, the business institution applies its criteria to make a decision on credit approval. For example, a business institution may have decisioning criteria that restricts credit limits offered to applicants who have poor payment histories, while offering premium rates or products to applicants with exceptional credit histories. Business institutions may change custom decisioning criteria often and for varying reasons. For example, a lender may decide to offer a special rate during a holiday season or create higher (or lower) standards for approval during difficult economic times. Accordingly, software designed to access credit information must apply the appropriate decisioning criteria. Ideally, credit decisioning is performed in real time, thus, software used to access credit information must be fast and reliable. A decision engine uses decisioning software to apply decisioning criteria to an application request or other decision. A “decision engine” is the term used to describe the system employed to retrieve credit information, apply decisioning criteria to the credit information, and provide the appropriate result to the business institution requesting the decision. Typically, a decision engine comprises hardware and software.

Two options exist for business institutions for accessing credit bureaus and applying decisioning criteria: the business institutions may implement an in-house solution or outsource these functions to a third party. While both options may be suitable for accessing and evaluating credit information, both have certain disadvantages. An “in-house” software solution often provides the greatest control for business institutions, but the costs of developing the software, purchasing the hardware, and hiring technical staff are expensive. Contracting a third party to develop, implement, and host the software solution may be cost-efficient, but business institutions lose control over the software and cannot make changes without notifying the third party. Such changes usually entail software testing that takes considerable time and effort by software programmers, thus delaying the implementation of the changes.

Therefore, there exists in the industry a need for systems and methods for providing business institutions with the capabilities of making changes to decisioning criteria quickly and reliably, while at the same time providing the advantages of outsourced software support.

### SUMMARY OF THE INVENTION

The present invention overcomes the limitations of the existing technology by providing a system and method for modifying criteria attributes of a decision engine. Generally, the system includes a criteria attribute unit, an acceptable criteria storage unit, and an active criteria storage unit.

The user requests a change in the decisioning criteria currently implemented in the decision engine. The criteria attribute unit receives the proposed change as proposed criteria attribute data and determines whether the proposed change is acceptable to implement into the productional decisioning process. The criteria attribute unit makes the determination based on acceptable criteria attribute data received by the acceptable criteria storage unit. If the proposed change qualifies as acceptable criteria attribute data, then the criteria attribute unit activates the proposed change by storing the proposed criteria attribute data in the active criteria storage unit. If the proposed criteria attribute data is not acceptable, then the criteria attribute data rejects the proposed change.

The system also includes a criteria testing unit and a testing processor. The criteria testing unit determines untested criteria attribute data by creating ranges of criteria attribute data that do not qualify as acceptable criteria attribute data. The criteria testing unit provides the untested criteria attribute data to the testing processor for testing. The testing processor simulates the productional decisioning process. By testing criteria before it is requested for activation, the system can ensure that proposed criteria attribute data will function appropriately with the productional decisioning process. After testing the untested criteria attribute data, the testing processor returns a result, i.e. success or failure, to the criteria testing unit. If the result is success, the criteria testing unit provides the criteria attribute data to the acceptable criteria storage unit for storage. If the result is failure, the criteria testing unit considers the criteria attribute data to be unacceptable.

Other objects, features, and advantages of the present invention will become apparent to those skilled in the art upon reading the following detailed description, when taken in conjunction with the accompanying drawings and appended claims.

### BRIEF DESCRIPTION OF DRAWINGS

FIG. 1 is a block diagram illustrating a system for modifying criteria attributes in accordance with an exemplary embodiment of the present invention.

FIG. 2 is a block diagram illustrating a system for testing criteria attributes in accordance with an exemplary embodiment of the present invention.

FIG. 3 is a flow diagram illustrating a method of modifying criteria attributes in accordance with an exemplary embodiment of the present invention.

FIG. 4 is a flow diagram illustrating a method for testing criteria attributes in accordance with an exemplary embodiment of the present invention.

### DETAILED DESCRIPTION OF INVENTION

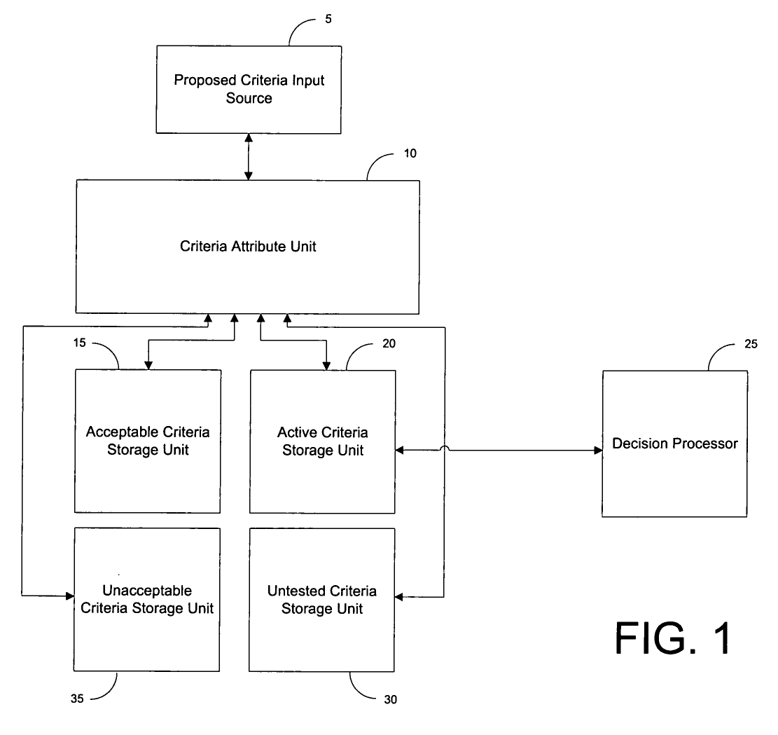

Referring now to the drawings, in which like numerals refer to like components or steps throughout the several views of the embodiments of the present invention. FIG. 1 is a block diagram illustrating a system for modifying criteria attributes in accordance with an exemplary embodiment of the present invention. The system provides a user with the ability to change decisioning criteria for a decision engine quickly and reliably.

In general, the criteria attribute unit 10 receives proposed criteria attribute data through user input provided via a proposed criteria input source 5, such as a local data terminal or computer (not shown), or any other desired and appropriate device. The proposed criteria input source 5 provides proposed criteria attribute data to the criteria attribute unit 10. The user input is entered through a user interface and transmitted to the criteria attribute unit 10. User input is preferably entered through a graphical user interface displayed on a computer display at the source 5. The user input can also provide the criteria attribute unit 10 with implementation data that indicates the date and time to implement or activate the proposed criteria attribute data. In an alternative embodiment of the present invention, when a user proposes to activate the proposed criteria attribute data a system administrator is notified (e.g., through an email message containing a security token) that a change has been requested. The administrator may then approve the requested change by a user (e.g., the administrator enters the security token received by email into the system). Only after administrator approval is the activation of the proposed criteria attribute data permitted.

The proposed criteria attribute data may be generated and inputted by a user, or may be generated and inputted by a software program, such as one which attempts to test the usable limits of the attribute data or attempts to determine previously unused or untested attributes for evaluation. The criteria attribute unit 10 then evaluates the proposed criteria attribute data with acceptable criteria data from the acceptable criteria storage unit 15.

If the proposed criteria attribute data is found in the acceptable criteria storage unit 15, then the proposed criteria attribute data is provided to the active criteria storage unit 20 for storage which modifies the previous active criteria attribute data to be the proposed criteria attribute data. If the proposed criteria attribute data is not found in the acceptable criteria storage unit 15, then the criteria attribute unit 10 compares the proposed criteria attribute data with the unacceptable criteria data from the unacceptable criteria storage unit 35. If the proposed criteria attribute data is found to be unacceptable criteria data, then the proposed criteria attribute data is rejected, the user is notified of the reason for the rejection, and the active criteria attribute data remains unchanged. If the proposed criteria attribute data is not found to be acceptable criteria attribute data and not found to be unacceptable criteria attribute data then the proposed criteria attribute data is provided to the untested criteria storage unit 30 for storage.

The decision processor 25 uses the active criteria data provided by the active criteria storage unit 20 for processing in the productional decisioning process. The productional decisioning process is the process that applies the decisioning criteria of the particular business to the credit information received from the credit bureaus in order to approve or deny credit to an applicant.

The acceptable criteria storage unit 15 stores the tested decisioning criteria that are acceptable to use in the productional decisioning process. Acceptable criteria attribute data is decisioning criteria that has been tested and approved for use in the productional decisioning process. Acceptable criteria attribute data may include discreet data elements or ranges of data elements.

Proposed criteria attribute data is decisioning criteria selected by a user that is to be incorporated in the productional decisioning process; however, the proposed criteria attribute data must be approved before being used in the productional decisioning process.

The active criteria storage unit 20 stores the active criteria attribute data used in the productional decisioning process. The active criteria attribute data is decisioning criteria currently selected by the particular business for the productional decisioning process.

The criteria attribute unit 10 communicates with the proposed criteria input source 5, the acceptable criteria storage unit 15, the active criteria storage unit 20, the untested criteria storage unit 30, and the unacceptable criteria storage unit 35, via any desired and appropriate communication devices and techniques including, but not limited to, intranet, Internet, local area network (LAN), wide area network (WAN), copper wire, coaxial cable, fiber optic cable, infrared devices, and RF signals.

In an exemplary embodiment of the present invention, the storage units 15, 20, 30, and 35 are memory devices capable of storing and retrieving data including, but not limited to, random access memory (RAM), flash memory, magnetic memory devices, optical memory devices, hard disk drives, removable volatile or non-volatile memory devices, optical storage mediums, magnetic storage mediums, hard disks, RAM memory cards, etc. Alternatively, a storage unit can be a remote storage facility accessible through a wired and/or wireless network system. In another embodiment of the present invention, a storage unit can be a memory system comprising a multi-stage system of primary and secondary memory devices, as mentioned above. The primary memory device and secondary memory device may operate as a cache for the other. Also, the secondary memory device can serve as a backup to the primary memory device. In yet another embodiment of the present invention, a storage unit can be a memory device configured as a simple database file. A storage unit is preferably, but not necessarily, implemented as a searchable database. Additionally, a storage unit can be a relational database using a structured-query-language (SQL). For example and not limitation, a storage unit may be as simple as a flat file listing the values or an HTML drop-down list incorporated within HTML code (static and/or dynamic).

The unacceptable criteria storage unit 35 provides unacceptable criteria attribute data to the criteria attribute unit 10. Unacceptable criteria attribute data is criteria attribute data that is not acceptable criteria attribute data. Generally, unacceptable criteria attribute data is identified when proposed criteria attribute data fails in the processing test. In an alternative embodiment of the present invention, unacceptable criteria attribute data is any data or range of data that is outside of acceptable criteria attribute data.

The untested criteria storage unit 30 receives untested criteria attribute data from the criteria attribute unit 10. Untested criteria attribute data includes criteria attribute data that is neither acceptable criteria attribute data nor unacceptable criteria attribute data.

One skilled in the art will recognize that the acceptable criteria storage unit 15, the active criteria unit 20, the untested criteria storage unit 30, and the unacceptable criteria storage unit 35 can constitute the same memory, device, or database, or can constitute completely separate, unrelated memory, devices, or databases.

In an alternative embodiment of the present invention, the criteria attribute unit 10 provides the proposed criteria attribute data to the acceptable criteria storage unit 15 and the unacceptable criteria storage unit 35. The acceptable criteria storage unit 15 compares the proposed criteria attribute data with acceptable criteria attribute data and returns a result, i.e. success or failure, to the criteria attribute unit 10. Likewise, the unacceptable criteria storage unit 35 compares the proposed criteria attribute data with unacceptable criteria attribute data and returns a result, i.e. success or failure, to the criteria attribute unit 10.

In an exemplary embodiment of the present invention, the system for modifying criteria attributes further comprises a decision processor 25. The decision processor 25 communicates with the active criteria storage unit 20 via any desired and appropriate communication devices and techniques, as previously mentioned. The decision processor 25 uses the active criteria attribute data provided by the active criteria storage unit 20 in the productional decisioning process. The decision processor 25 may comprise a single computer processing unit or multiple computer processing units. In another exemplary embodiment of the present invention, the decision processor 25 provides processing results to other computer processes or devices (not shown) via a network or non-network computer system.

The present invention thus provides for real-time modification of criteria attributes for a decision engine computer process. For example, the system can be implemented through a common gateway interface (CGI) program available on the Internet, or similarly through an application service provider (ASP) environment. Accordingly, the present invention may be activated by a user located remotely from the computer system or server housing the implementation of the system. The lending institution accesses the program to request a change in the criteria currently applied to credit applications. If the lending institution currently denies credit to individuals making less than $40,000 who have not resided at the same address for more than one year, then the lending institution could, at its discretion, change the dollar amount to $35,000 and the residency requirement to six months. The proposed criteria changes are submitted to the system for processing. The system must determine whether the proposed criteria changes can be applied without causing computational errors by the decision engine computer process. If the system determines that the proposed criteria changes are acceptable, then the system activates the changes. Thus, for each subsequent credit application processed, the new criteria would be applied.

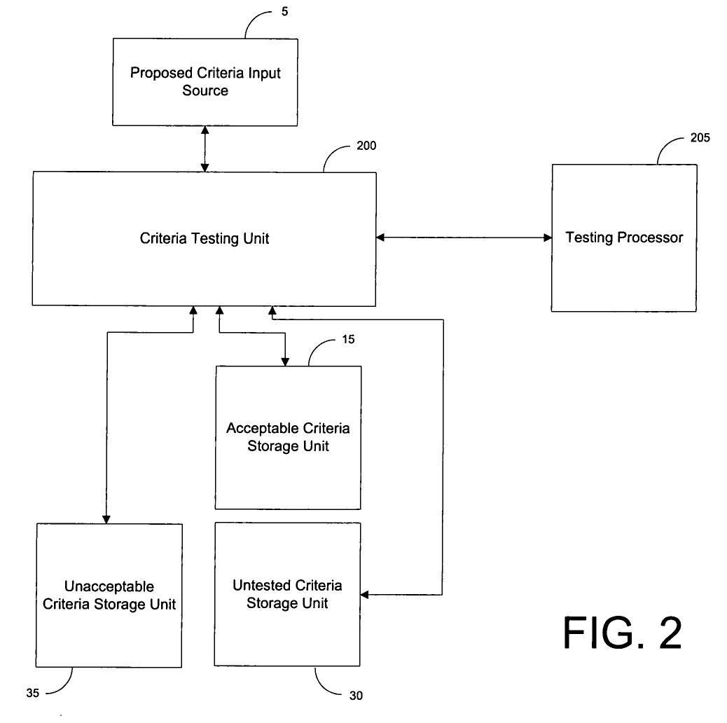

FIG. 2 is a block diagram illustrating a system for testing criteria attributes in accordance with an exemplary embodiment of the present invention. In general, the criteria testing unit 200 receives or creates testing criteria attribute data. Testing criteria attribute data is decisioning criteria that has not been approved or tested for the productional decisioning process. The criteria testing unit 200 receives untested criteria attribute data as testing criteria attribute data from the untested criteria storage unit 30. The criteria testing unit 200 provides the testing processor 205 with the testing criteria attribute data to test under production conditions. If the testing criteria attribute data runs successfully on the testing processor 205, then the testing criteria attribute data is stored in the acceptable criteria storage unit 15. If the testing criteria attribute data runs unsuccessfully on the testing processor 205, then the testing criteria attribute data is stored in the unacceptable criteria storage unit 35. Usually, but not necessarily, the testing of testing criteria attribute data is done prior to a user proposing such data, thus facilitating a quick and reliable modification of the decisioning criteria.

The system for testing criteria attributes generally comprises a criteria testing unit 200, the acceptable criteria storage unit 15, and a testing processor 205. The criteria testing unit 200 communicates with the acceptable criteria storage unit 15 and the testing processor 205 via any desired and appropriate communication device or technique, as previously mentioned. The criteria testing unit 200 receives testing criteria attribute data through user input or through software generated input, as previously mentioned. In a preferred embodiment of the present invention, the criteria testing unit 200 can create testing criteria attribute data by formulating testing criteria data from the received acceptable criteria attribute data or from proposed criteria attribute data provided by the user.

The testing processor 205 uses the testing criteria attribute data provided by the criteria testing unit 200 in a computer process that simulates the productional decisioning process. The testing processor 205 provides the criteria testing unit 200 with the success status of the testing criteria attribute data. The success status indicates to the criteria testing unit 200 whether the testing criteria attribute data should be considered acceptable criteria attribute data or whether the testing criteria attribute data should be considered unacceptable criteria attribute data. The testing processor 205 can also provide processing results to other computer processes or devices (not shown) via a network or non-network computer system. The testing processor 205 can be configured as described above with regard to the decision processor 25, or can be incorporated into the decision processor 25.

The testing criteria attribute data can be received by the criteria testing unit 200 through user input via the proposed criteria input source 5, or any other desired and appropriate input source, as previously mentioned.

Alternatively, the system for testing criteria attributes can additionally comprise the unacceptable criteria storage unit 35. The unacceptable criteria storage unit 35 communicates with the criteria testing unit 200 via any desired and appropriate communication devices and techniques, as previously mentioned. The criteria testing unit 200 can use unacceptable criteria attribute data received from the unacceptable criteria storage unit 35 to calculate testing criteria attribute data to send to the testing processor 205. The criteria testing unit 200 can determine ranges of testing criteria attribute data that do not qualify as either unacceptable criteria attribute data or acceptable criteria attribute data. This determination can be accomplished by determining the ranges of criteria data beyond those found in the acceptable criteria attribute data and the unacceptable criteria attribute data. After processing, if the testing processor 205 returns a success status, the qualified range of the testing criteria attribute data may be stored as acceptable criteria attribute data in the acceptable criteria storage unit 15. If the testing processor 205 returns a failure status, the testing criteria attribute data can be stored as unacceptable criteria attribute data in the unacceptable criteria storage unit 35.

In an alternative embodiment of the present invention, the criteria testing unit 200 requests testing criteria attribute data from the acceptable criteria storage unit 15 and the unacceptable criteria storage unit 35. The acceptable criteria storage unit 15 creates testing criteria attribute data by examining acceptable criteria attribute data and returns the testing criteria attribute data to the criteria testing unit 200. Likewise, the unacceptable criteria storage unit 35 creates testing criteria attribute data by examining unacceptable criteria attribute data and returns the testing criteria attribute data to the criteria testing unit 200. The acceptable criteria storage unit 15 creates testing criteria attribute data by determining ranges of criteria data outside the range of acceptable criteria attribute data. Similarly, the unacceptable criteria storage unit 35 creates testing criteria attribute data by determining ranges of criteria data outside the range of unacceptable criteria attribute data.

In another embodiment of the present invention, the system for testing criteria attributes further comprises the untested criteria storage unit 30. Generally, the untested criteria attribute data is received when a user requests criteria attribute data that has not previously been tested. The untested criteria storage unit 30 communicates with the criteria testing unit 200 via any desired and appropriate communication devices and techniques, as previously mentioned. The untested criteria storage unit 30 provides untested criteria attribute data as testing criteria attribute data to the criteria testing unit 200. The criteria testing unit 200 provides the testing criteria attribute data to the testing processor 205 for processing. As described above, if the testing processor 205 returns a success status, the testing criteria attribute data can be stored as acceptable criteria attribute data in the acceptable criteria storage unit 15. If the testing processor 205 returns a failure status, then the testing criteria attribute data can be stored as unacceptable criteria attribute data in the unacceptable criteria storage unit 35.

Thus, the present invention also tests criteria to determine whether it is acceptable for use in the decision engine computer process, if the criteria has not been approved for use in the decision engine computer process. The criteria is tested for compatibility with the decision engine computer process. If the system determines that the criteria is compatible, the criteria is stored as acceptable criteria. If, for example, the acceptable criteria is used to approve criteria proposed by a lending institution, then the significance of testing the criteria cannot be understated. Implementing decisioning criteria into the productional decisioning process without proper testing imposes a significant risk for failure of the productional decisioning process, thus, causing potentially disastrous results, e.g., a high rate of loan defaults. Therefore, lending institutions rely heavily on this decisioning process and demand that it not fail. To protect the integrity of the critical, productional decisioning process, criteria is tested on a test system that runs a process closely resembling the productional decisioning process.

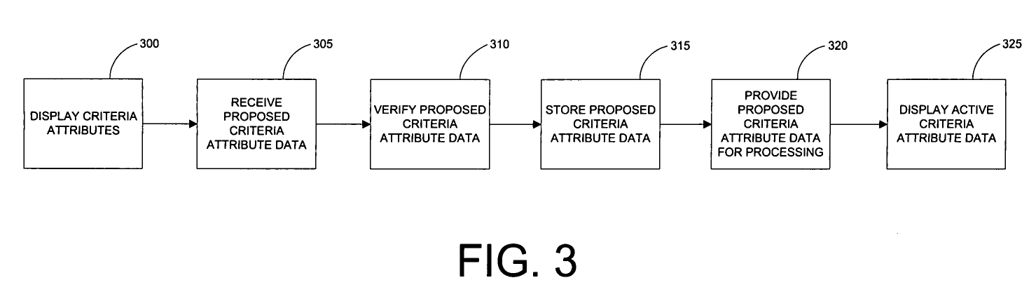

FIG. 3 is a flow diagram illustrating a method of modifying criteria attributes in accordance with an exemplary embodiment of the present invention. Initially, potential criteria attributes are displayed 300 to the user. The user may make a selection from the displayed criteria attributes. The user input can also provide implementation data that indicates the date and time to implement or activate the proposed criteria attribute data.

The criteria attribute unit 10 receives 305 proposed criteria attribute data, as described above. The criteria attribute unit 10 verifies 310 whether the proposed criteria attribute data is acceptable criteria attribute data, unacceptable criteria attribute data, or neither. The criteria attribute unit 10 receives acceptable criteria attribute data from the acceptable criteria storage unit 15. Likewise, the criteria attribute unit 10 receives unacceptable criteria attribute data from the unacceptable criteria storage unit 35. The criteria attribute unit 10 then determines whether the proposed criteria attribute data is an element, subset, or within range of the acceptable criteria attribute data; an element, subset, or within range of the unacceptable criteria attribute data; or neither acceptable criteria attribute data nor unacceptable criteria attribute data.

Alternatively, the criteria attribute unit 10 provides the proposed criteria attribute data to the acceptable criteria storage unit 15 and the unacceptable criteria storage unit 35. The acceptable criteria storage unit 15 compares the proposed criteria attribute data with the acceptable criteria attribute data and returns the result, i.e. success or failure, to the criteria attribute unit 10. Similarly, the unacceptable criteria storage unit 35 compares the proposed criteria attribute data with the unacceptable criteria attribute data and returns the result, i.e. success of failure, to the criteria attribute unit 10.

After verifying whether the proposed criteria attribute data is acceptable criteria attribute data or unacceptable criteria attribute data, the proposed criteria attribute data is stored 315. If the proposed criteria attribute data is acceptable criteria attribute data, then, in a preferred embodiment of the present invention, the proposed criteria attribute data is stored 315 in the active criteria storage unit 20. If the proposed criteria attribute data is unacceptable criteria attribute data, then the proposed criteria attribute data is rejected. If the proposed criteria attribute data is neither acceptable criteria attribute data nor unacceptable criteria attribute data, then the proposed criteria attribute data is stored 315 in the untested criteria storage unit 30.

If the stored proposed criteria attribute data is acceptable criteria attribute data, then it is provided 320 to the decision engine computer process for processing. The stored proposed criteria attribute data becomes active criteria attribute data for purposes of the computer process executed by the decision processor 25. One skilled in the art will recognize that data can be activated by changing an activation bit or flag in the database to indicate that the stored data is active, or by storing the data in a separate database reserved for active criteria attribute data. The activation can be done manually through user input or automatically by a computer process such as, but not limited to, a cron job or a task manager scheduled task.

Finally, the active criteria attribute data is displayed 325 on a computer display. If the proposed criteria attribute data is unacceptable criteria attribute data, a failure status is displayed. If the proposed criteria attribute data is neither acceptable criteria attribute data nor unacceptable criteria attribute data, then a message is displayed to indicate that the proposed criteria attribute data cannot be activated until it is properly tested. The active criteria attribute data can be displayed as described above with regard to displaying proposed criteria attribute data.

In an alternative embodiment of the present invention, the steps of displaying criteria attributes 300 and displaying active criteria attribute data 325 are optional.

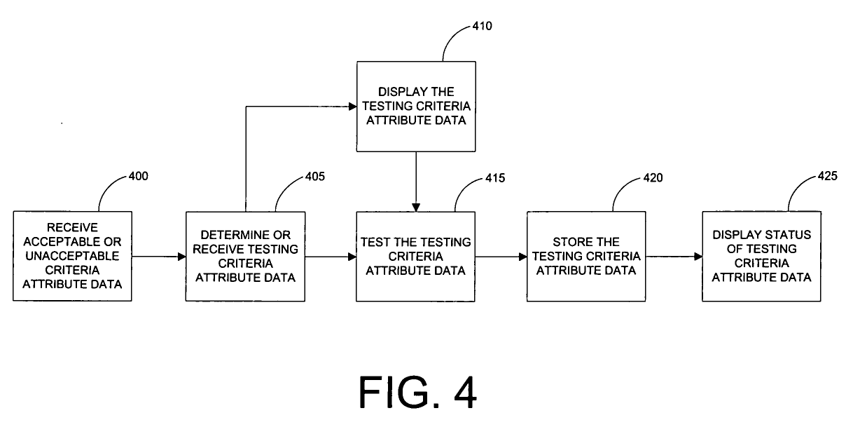

FIG. 4 is a flow diagram illustrating a method for testing criteria attributes in accordance with an exemplary embodiment of the present invention. Initially, the criteria testing unit 200 receives 400 acceptable criteria attribute data and unacceptable criteria attribute data from the acceptable criteria storage unit 15 and the unacceptable criteria storage unit 35, respectively, or through an external source such as user input or software generated input.

Next, testing criteria attribute data is determined 405. The testing criteria attribute data can be determined 405 from the acceptable criteria attribute data and unacceptable criteria attribute data. In an exemplary embodiment of the present invention, the testing criteria attribute data is determined 405 through a computer process that uses acceptable criteria attribute data and unacceptable criteria attribute data to calculate new, testing criteria attribute data that is not an element or subset of the acceptable criteria attribute data or unacceptable criteria attribute data. Alternatively, the testing criteria attribute data can be determined 405 by receiving untested criteria attribute data as testing criteria attribute data from the untested criteria storage unit 30. One skilled in the art will recognize that the testing criteria attribute data may be determined by a computer process, or may be inputted manually or externally by a user or data file.

Alternatively, the acceptable criteria storage unit 15 and the unacceptable criteria storage unit 35 determines testing criteria attribute data, as described above, and returns the testing criteria attribute data to the criteria testing unit 200.

The testing criteria attribute data is displayed 410 to the user and then tested 415 on the testing processor 205. The testing processor 205 reports to the criteria testing unit 200 the results, i.e. success or failure. If a failure, then the testing criteria attribute data is stored 420 in the unacceptable criteria storage unit 35. If a success, then the testing criteria attribute data is stored 420 in the acceptable criteria storage unit 15. Finally, the result, i.e. success or failure, of the testing criteria attribute data is displayed 425.

In an alternative embodiment of the present invention, the steps of displaying the testing criteria attribute data 410 and displaying the status of the testing criteria attribute data 425 are optional.

While this invention has been described in detail with particular reference to exemplary embodiments thereof, it will be understood that variations and modifications can be effected within the scope of the invention as defined in the appended claims.

What is claimed is:

1. A system for modifying criteria attributes of a decision engine, the system comprising:
an acceptable criteria storage unit adapted to store acceptable criteria attribute data;
an active criteria storage unit adapted to store active criteria attribute data and to provide said active criteria attribute data to the decision engine; and
a criteria attribute unit in communication with said acceptable criteria storage unit and said active criteria storage unit, wherein said criteria attribute unit is adapted to receive proposed criteria attribute data, compare said proposed criteria attribute data with said acceptable criteria attribute data to determine whether said proposed criteria attribute data is acceptable criteria attribute data, and to provide said proposed criteria attribute data as active criteria attribute data to the active criteria storage unit for storage if said proposed criteria attribute data is determined to be acceptable criteria attribute data.

2. The system of claim 1, further comprising a decision processor in communication with said active criteria database, said decision processor adapted to receive active criteria attribute data from said active criteria database for processing in the decision engine.

3. The system of claim 1, said system further comprising:
an unacceptable criteria storage unit in communication with said criteria attribute unit, said unacceptable criteria storage unit adapted to provide unacceptable criteria attribute data to said criteria attribute unit; and
said criteria attribute unit further adapted to compare said proposed criteria attribute data with said unacceptable criteria attribute data to determine whether said proposed criteria attribute data is unacceptable criteria attribute data, and to return a result status if said proposed criteria attribute data is determined to be unacceptable criteria attribute data.

4. The system of claim 3, said system further comprising an untested criteria storage unit in communication with said criteria attribute unit, said untested criteria storage unit adapted to store untested criteria attribute data, and to receive criteria attribute data as untested criteria attribute data from said criteria attribute unit when said criteria attribute unit determines that said proposed criteria attribute data is not acceptable criteria attribute data and not unacceptable criteria attribute data.

5. The system of claim 1, wherein said proposed criteria attribute data is received from a remote user via a wide-area network.

6. The system of claim 5, wherein said wide area network utilizes an application service provider (ASP) environment.

7. The system of claim 1, wherein said criteria attribute unit determines whether said proposed criteria attribute data is acceptable criteria attribute data by evaluating whether an element of said proposed criteria attribute data is a member of said acceptable criteria attribute data.

8. The system of claim 1, wherein said criteria attribute unit determines whether said proposed criteria attribute data is acceptable criteria attribute data by evaluating whether a range of said proposed criteria attribute data is a member of said acceptable criteria attribute data.

9. The system of claim 3, wherein said criteria attribute unit determines whether said proposed criteria attribute data is unacceptable criteria attribute data by evaluating whether an element of said proposed criteria attribute data is a member of said unacceptable criteria attribute data.

10. The system of claim 3, wherein said criteria attribute unit determines whether said proposed criteria attribute data is unacceptable criteria attribute data by evaluating whether a range of said proposed criteria attribute data is a member of said unacceptable criteria attribute data.

11. The system of claim 1, wherein said criteria attribute unit is adapted to provide said proposed criteria attribute data as active criteria attribute data to the active criteria storage unit for storage at a predetermined time.

12. The system of claim 1, wherein said criteria attribute unit is adapted to provide said proposed criteria attribute data as active criteria attribute data to the active criteria storage unit for storage after receiving an approval notification.

13. The system of claim 12, wherein said approval notification comprises an approval token received from a system administrator.

14. A system for testing criteria attributes of a decision engine, the system comprising:
an acceptable criteria storage unit adapted to store and provide acceptable criteria attribute data;
a testing processor adapted to receive testing criteria attribute data, process said testing criteria attribute data in a testing process, and provide the success or failure status of said testing process; and
a criteria testing unit in communication with said acceptable criteria storage unit and said testing processor, wherein said criteria testing unit is adapted to provide testing criteria attribute data to said testing processor, and provide said testing criteria attribute data to said acceptable criteria storage unit as acceptable criteria attribute data if said testing process returns a success status.

15. The system of claim 14, said system further comprising an unacceptable criteria storage unit in communication with said criteria testing unit, said unacceptable criteria storage unit adapted to receive testing criteria attribute data as unacceptable criteria attribute data from said criteria testing unit if said testing process returns a failure status.

16. The system of claim 14, said system further comprising an untested criteria storage unit in communication with said criteria testing unit, said untested criteria storage unit adapted to provide untested criteria attribute data as testing criteria attribute data to said criteria testing unit.

17. The system of claim 16, wherein said criteria testing unit is further adapted to
receive acceptable criteria attribute data and unacceptable criteria attribute data;
create testing criteria attribute data that is not acceptable criteria attribute data and not unacceptable criteria attribute data; and
provide testing criteria attribute data as untested criteria attribute data to said untested criteria storage unit.

18. The system of claim 17, wherein said criteria testing unit is further adapted to create testing criteria attribute data by determining sets of criteria attribute data beyond current upper and lower values of said acceptable criteria attribute data and said unacceptable criteria attribute data.

19. The system of claim 14, wherein said testing criteria attribute data is received from a remote user via a wide-area network.

20. A method for modifying criteria attributes used in a decision engine computer process, the method comprising:
receiving proposed criteria attribute data;
verifying that said proposed criteria attribute data qualifies as acceptable criteria attribute data;
storing said proposed criteria attribute data into a memory; and
providing said proposed criteria attribute data to the decision engine computer process if said proposed criteria attribute data qualifies as acceptable criteria attribute data, wherein said proposed criteria attribute data is classified as active criteria attribute data.

21. The method of claim 20, wherein providing said proposed criteria attribute data to the decision engine computer process if said proposed criteria attribute data qualifies as acceptable criteria attribute data comprises providing said proposed criteria attribute data to the decision engine computer process at a predetermined time.

22. The method of claim 20, wherein providing said proposed criteria attribute data to the decision engine computer process if said proposed criteria attribute data qualifies as acceptable criteria attribute data comprises providing said proposed criteria attribute data to the decision engine computer process after receiving an approval notification.

23. The method of claim 20, wherein said method further comprises the step of displaying at least one criteria attribute.

24. The method of claim 20, wherein said method further comprises the step of displaying active criteria attribute data.

25. The method of claim 20, wherein said method further comprises the step of verifying that said proposed criteria attribute data does not qualify as unacceptable criteria attribute data.

26. The method of claim 25, wherein said method further comprises the step of storing said proposed criteria attribute data into memory if proposed criteria attribute data does not qualify as acceptable criteria attribute data and does not qualify as unacceptable criteria attribute data, wherein said proposed criteria attribute data is classified as untested criteria attribute data.

27. A method for testing criteria attributes used in a decision engine computer process, the method comprising:
receiving acceptable criteria attribute data from memory;
determining testing criteria attribute data from said acceptable criteria attribute data, wherein said testing criteria attribute data is not acceptable criteria attribute data;
testing said testing criteria attribute data in a computer process; and
storing said testing criteria attribute data into memory, wherein said testing criteria attribute data is classified as acceptable criteria attribute data if the computer process returns a success status.

28. The method of claim 27, wherein said method further comprises the steps of:
receiving unacceptable criteria attribute data from memory; and
determining testing criteria attribute data from said unacceptable criteria attribute data, wherein said testing criteria attribute data is not unacceptable criteria attribute data.

29. The method of claim 27, wherein said method further comprises the step of receiving untested criteria attribute data from memory, wherein said untested criteria attribute data is classified as testing criteria attribute data.

30. The method of claim 27, wherein said method further comprises the step of displaying said testing criteria attribute data.

31. The method of claim 27, wherein said method further comprises the step of displaying the status of said testing criteria attribute data.
